(19) United States
(12) Patent Application Publication
(10) Pub. No.: US 2013/0055159 A1
(43) Pub. Date: Feb. 28, 2013

(54) SYSTEMS AND METHODS FOR AN IMPROVED TOUCHSCREEN INTERFACE

(71) Applicants: Jonathan Levine, South Orange, NJ (US); Doug Chasman, Pittsford, NY (US); Daniel L. Pletter, San Francisco, CA (US)

(72) Inventors: Jonathan Levine, South Orange, NJ (US); Doug Chasman, Pittsford, NY (US); Daniel L. Pletter, San Francisco, CA (US)

(73) Assignee: salesforce.com, inc., San Francisco, CA (US)

(21) Appl. No.: 13/593,271

(22) Filed: Aug. 23, 2012

Related U.S. Application Data
(60) Provisional application No. 61/526,406, filed on Aug. 23, 2011.

(51) Int. Cl. G06F 3/048

(52) U.S. Cl. 715/810

(57) ABSTRACT

A row displayed on a touchscreen surface of a portable electronic device is linked to a first resource and includes at least one link to a second resource. A technique allows the row to have a first tap target for accessing the first resource and a second tap target for accessing the second resource. An area of the first tap target is greater than an area of the second tap target. This provides a large surface area for tapping the first tap target in order to easily access the first resource. The second resource can still be accessed by tapping the second tap target.

### CLAIM OF PRIORITY

This application claims the benefit of U.S. Provisional Patent Application 61/526,406, entitled SYSTEMS AND METHODS FOR AN IMPROVED TOUCHSCREEN INTERFACE, filed Aug. 23, 2011, (Attorney Docket No. 735PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to computer systems and software, and, more particularly, to improving the user experience during interactions with a touchscreen display in an on-demand services environment.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

A touchscreen is an electronic visual display that can detect the presence and location of a touch within the display area. On a device with a touchscreen display, a user can provide input by touching the display surface with their finger. Touchscreens have found their way into many of today's portable electronic devices such as smartphones and tablet computers.

Such devices typically have very small displays. This allows the device to be easily transported and carried. However, interacting with the device through a touch or tap can be difficult and frustrating because the displayed screen elements can be very small compared to a person's finger or thumb. For example, in some cases a user will use their finger to select an item shown on the display, but may have intended to select a different item.

Therefore, there is a need for improved systems and techniques for interacting with information shown on a touchscreen display.

### BRIEF SUMMARY

In an embodiment, a row displayed on a touchscreen surface of a portable electronic device is linked to a first resource and includes at least one link to a second resource. A technique allows the row to have a first tap target for accessing the first resource and a second tap target for accessing the second resource. An area of the first tap target is greater than an area of the second tap target. This provides a large surface area for tapping the first tap target in order to easily access the first resource. The second resource can still be accessed by tapping the second tap target.

More particularly, disclosed herein is a system and method for an improved touchscreen interface. iOS devices, such as the Apple iPhone® and Apple iPad® are examples of devices having a touchscreen interface; however, while iOS devices are referenced herein, a person having ordinary skill in the art will appreciate that other devices may incorporate one or more embodiments of this disclosure. In addition, one or more examples disclosed herein reference interfacing a Salesforce® CRM application on a touchscreen device; however, other applications may also use one or more of embodiments of this disclosure.

On an iOS device, users may have a feature that provides selecting a row and subsequently navigating to a separate page displayed in the app or on a browser. However, in some apps, there may be two or more links in a row. For example, in a case related list in the Salesforce app, there could be a link that navigates to the associated contact that filed the case. In a specific implementation, it would be desirable for a user to be able to click on any part of the row to navigate to the case and the contact link to navigate to the contact.

In an embodiment, an “onclick” javascript event may be attached to a row's LI element. The javascript code checks to see the target of the click. If the target's tag name is “a” (the HTML markup for a link), the javascript does not fire a “row press” event for that row. “Row press” events typically change the window location to the url specified by that row. In this fashion, a user is presented with large areas in the interface that may be clicked, as well as smaller “sub-click” regions.

In a specific implementation, a method includes providing a table accessible through a touchscreen interface, the table include at least one row; and, providing at least one sub-click region in the at least one row.

In an embodiment and by way of example, a method for an improved touchscreen interface includes displaying a set of rows on a touchscreen display surface of a portable electronic device, each row being linked to a first resource, and each row including at least one link to a second resource, and two or more columns, receiving a user input tap on a row of the set of rows displayed on the touchscreen display surface, if the user input tap is on a first region within the row that is occupied by the at least one link, providing the first resource, and if the user input tap is on a second region within the row that is outside of the first region, providing the second resource, where the second region covers at least a portion of a first column of the two or more columns of the row, and at least a portion of a second column of the two or more columns of the row.

The first resource may include a first record stored in a first database, and the second resource may include a second record stored in a second database, different from the first database. The second region may include a first portion and a second portion, where the first region is between the first portion and the second portion.

In a specific embodiment, the method includes transmitting from the portable electronic device to a server a request for a record identified by an attribute shown in the row, receiving the record at the portable electronic device, and displaying attributes of the record on the portable electronic device.

In another specific embodiment, the method includes attaching an onclick event to the row in order to fire, upon user selection of the row, a row press event to provide the second resource, after the receiving a user input tap, checking a target of the user input tap, if the target is on the at least one link, not firing the row press event, and if the target is not on the at least one link, firing the row press event.

While one or more implementations and techniques are described with reference to an embodiment in which an improved touchscreen interface is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a block diagram of an example of an environment wherein an on-demand database service implementing an embodiment of an improved touchscreen interface might be used; and

FIG. 2 illustrates a block diagram of an embodiment of elements of FIG. 1 and various possible interconnections between these elements.

FIG. 3 illustrates a representative system for an improved touchscreen interface in an embodiment;

FIG. 4 is an operational flow diagram illustrating a high level overview of a technique for an improved touchscreen interface in an embodiment;

FIG. 5 illustrates an example of a row displayed on a touchscreen having an improved interface in an embodiment;

FIG. 6 illustrates another example of a row displayed on a touchscreen having an improved interface in an embodiment;

FIG. 7 illustrates another example of a row displayed on a touchscreen having an improved interface in an embodiment;

### DETAILED DESCRIPTION

Systems and methods are provided for an improved touchscreen interface. As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

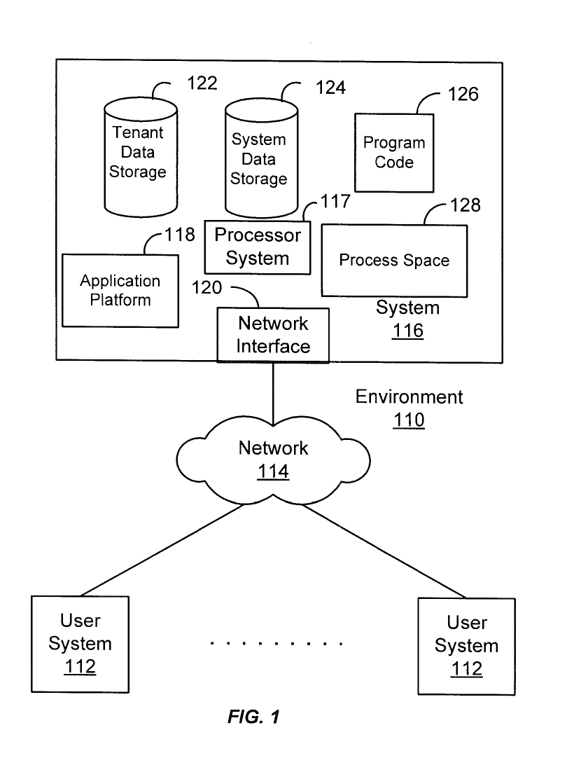

FIG. 1 illustrates a block diagram of an environment 110 wherein an on-demand database service implementing an embodiment of a system and method for an improved touchscreen interface might be used. Environment 110 may include user systems 112, network 114, system 116, processor system 117, application platform 118, network interface 120, tenant data storage 122, system data storage 124, program code 126, and process space 128. In other embodiments, environment 110 may not have all of the components listed and/or may have other elements instead of, or in addition to, those listed above.

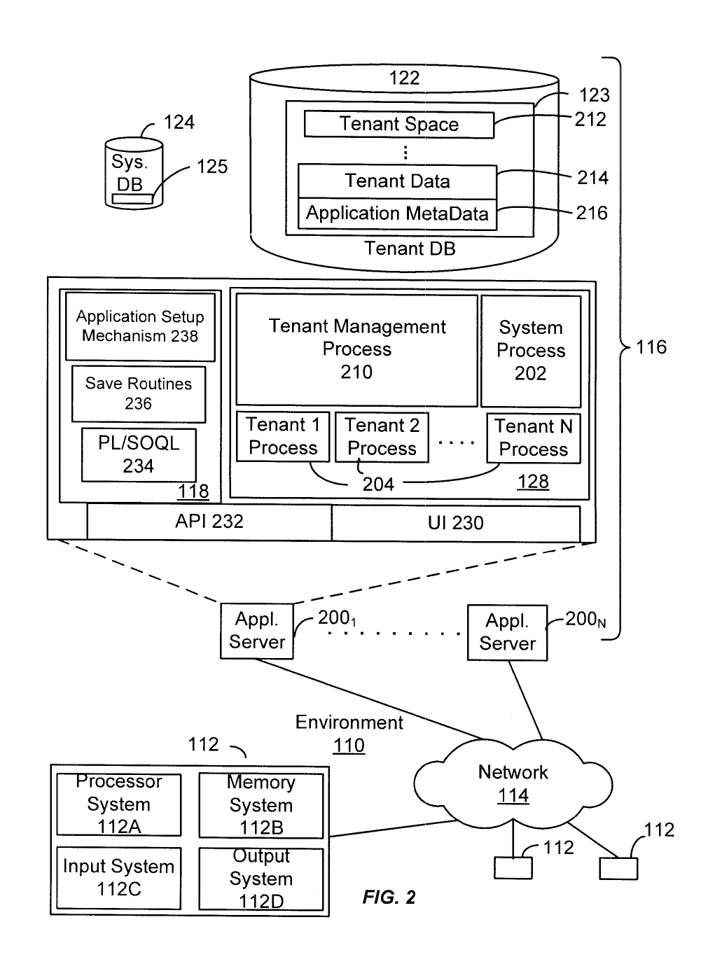

Environment 110 is an environment in which an on-demand database service exists. User system 112 may be any machine or system that is used by a user to access a database user system. For example, any of user systems 112 can be a handheld computing device, a mobile phone, a laptop computer, a work station, and/or a network of computing devices. As illustrated in FIG. 1 (and in more detail in FIG. 2) user systems 112 might interact via a network 114 with an on-demand database service, which is system 116.

An on-demand database service, such as system 116, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 116” and “system 116” will be used interchangeably herein. A database image may include one or more database objects. A relational database management system (RDMS) or the equivalent may execute storage and retrieval of information against the database object(s). Application platform 118 may be a framework that allows the applications of system 116 to run, such as the hardware and/or software, e.g., the operating system. In an embodiment, on-demand database service 116 may include an application platform 118 that enables creation, managing and executing one or more applications developed by the provider of the on-demand database service, users accessing the on-demand database service via user systems 112, or third party application developers accessing the on-demand database service via user systems 112.

The users of user systems 112 may differ in their respective capacities, and the capacity of a particular user system 112 might be entirely determined by permissions (permission levels) for the current user. For example, where a salesperson is using a particular user system 112 to interact with system 116, that user system has the capacities allotted to that salesperson. However, while an administrator is using that user system to interact with system 116, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 114 is any network or combination of networks of devices that communicate with one another. For example, network 114 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 112 might communicate with system 116 using TCP/IP and, at a higher network level, use other common Internet protocols to communicate, such as HTTP, FTP, AFS, WAP, etc. In an example where HTTP is used, user system 112 might include an HTTP client commonly referred to as a “browser” for sending and receiving HTTP messages to and from an HTTP server at system 116. Such an HTTP server might be implemented as the sole network interface between system 116 and network 114, but other techniques might be used as well or instead. In some implementations, the interface between system 116 and network 114 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 116, shown in FIG. 1, implements a web-based customer relationship management (CRM) system. For example, in one embodiment, system 116 includes application servers configured to implement and execute CRM software applications as well as provide related data, code, forms, webpages and other information to and from user systems 112 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 116 implements applications other than, or in addition to, a CRM application. For example, system 116 may provide tenant access to multiple hosted (standard and custom) applications, including a CRM application. User (or third party developer) applications, which may or may not include CRM, may be supported by the application platform 118, which manages creation, storage of the applications into one or more database objects and executing of the applications in a virtual machine in the process space of the system 116.

One arrangement for elements of system 116 is shown in FIG. 1, including a network interface 120, application platform 118, tenant data storage 122 for tenant data 123, system data storage 124 for system data 125 accessible to system 116 and possibly multiple tenants, program code 126 for implementing various functions of system 116, and a process space 128 for executing MTS system processes and tenant-specific processes, such as running applications as part of an application hosting service. Additional processes that may execute on system 116 include database indexing processes.

Several elements in the system shown in FIG. 1 include conventional, well-known elements that are explained only briefly here. For example, each user system 112 could include a desktop personal computer, workstation, laptop, PDA, cell phone, or any wireless access protocol (WAP) enabled device or any other computing device capable of interfacing directly or indirectly to the Internet or other network connection. User system 112 typically runs an HTTP client, e.g., a browsing program, such as Microsoft's Internet Explorer browser, Google's Chrome browser, Mozilla's Firefox browser, Apple's Safari browser, Netscape's Navigator browser, Opera's browser, or a WAP-enabled browser in the case of a cell phone, smartphone, PDA or other wireless device, or the like, allowing a user (e.g., subscriber of the multi-tenant database system) of user system 112 to access, process and view information, pages and applications available to it from system 116 over network 114. Each user system 112 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 116 or other systems or servers. For example, the user interface device can be used to access data and applications hosted by system 116, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 112 and all of its components are operator configurable using applications, such as a browser, including computer code run using a central processing unit such as an Intel Pentium® processor or the like. Similarly, system 116 (and additional instances of an MTS, where more than one is present) and all of their components might be operator configurable using application(s) including computer code to run using a central processing unit such as processor system 117, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 116 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Oracle America, Inc.).

According to one embodiment, each system 116 is configured to provide webpages, forms, applications, data and media content to user (client) systems 112 to support the access by user systems 112 as tenants of system 116. As such, system 116 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 2 also illustrates environment 110. However, in FIG. 2 elements of system 116 and various interconnections in an embodiment are further illustrated. FIG. 2 shows that user system 112 may include processor system 112A, memory system 112B, input system 112C, and output system 112D. FIG. 2 shows network 114 and system 116. FIG. 2 also shows that system 116 may include tenant data storage 122, tenant data 123, system data storage 124, system data 125, User Interface (UI) 230, Application Program Interface (API) 232, PL/SOQL 234, save routines 236, application setup mechanism 238, applications servers 200₁-200_{N}, system process space 202, tenant process spaces 204, tenant management process space 210, tenant storage area 212, user storage 214, and application metadata 216. In other embodiments, environment 110 may not have the same elements as those listed above and/or may have other elements instead of, or in addition to, those listed above.

User system 112, network 114, system 116, tenant data storage 122, and system data storage 124 were discussed above in FIG. 1. Regarding user system 112, processor system 112A may be any combination of one or more processors. Memory system 112B may be any combination of one or more memory devices, short term, and/or long term memory. Input system 112C may be any combination of input devices, such as one or more keyboards, mice, trackballs, scanners, cameras, and/or interfaces to networks. Output system 112D may be any combination of output devices, such as one or more monitors, printers, and/or interfaces to networks. As shown by FIG. 2, system 116 may include a network interface 120 (of FIG. 1) implemented as a set of HTTP application servers 200, an application platform 118, tenant data storage 122, and system data storage 124. Also shown is system process space 202, including individual tenant process spaces 204 and a tenant management process space 210. Each application server 200 may be configured to tenant data storage 122 and the tenant data 123 therein, and system data storage 124 and the system data 125 therein to serve requests of user systems 112. The tenant data 123 might be divided into individual tenant storage areas 212, which can be either a physical arrangement and/or a logical arrangement of data. Within each tenant storage area 212, user storage 214 and application metadata 216 might be similarly allocated for each user. For example, a copy of a user's most recently used (MRU) items might be stored to user storage 214. Similarly, a copy of MRU items for an entire organization that is a tenant might be stored to tenant storage area 212. A UI 230 provides a user interface and an API 232 provides an application programmer interface to system 116 resident processes to users and/or developers at user systems 112. The tenant data and the system data may be stored in various databases, such as one or more Oracle™ databases.

Application platform 118 includes an application setup mechanism 238 that supports application developers' creation and management of applications, which may be saved as metadata into tenant data storage 122 by save routines 236 for execution by subscribers as one or more tenant process spaces 204 managed by tenant management process 210 for example. Invocations to such applications may be coded using PL/SOQL 34 that provides a programming language style interface extension to API 232. A detailed description of some PL/SOQL language embodiments is discussed in commonly owned U.S. Pat. No. 7,730,478 entitled, METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is incorporated in its entirety herein for all purposes. Invocations to applications may be detected by one or more system processes, which manages retrieving application metadata 216 for the subscriber making the invocation and executing the metadata as an application in a virtual machine.

Each application server 200 may be communicably coupled to database systems, e.g., having access to system data 125 and tenant data 123, via a different network connection. For example, one application server 200₁ might be coupled via the network 114 (e.g., the Internet), another application server 200_{N-1} might be coupled via a direct network link, and another application server 200_{N} might be coupled by yet a different network connection. Transfer Control Protocol and Internet Protocol (TCP/IP) are typical protocols for communicating between application servers 200 and the database system. However, it will be apparent to one skilled in the art that other transport protocols may be used to optimize the system depending on the network interconnect used.

In certain embodiments, each application server 200 is configured to handle requests for any user associated with any organization that is a tenant. Because it is desirable to be able to add and remove application servers from the server pool at any time for any reason, there is preferably no server affinity for a user and/or organization to a specific application server 200. In one embodiment, therefore, an interface system implementing a load balancing function (e.g., an F5 Big-IP load balancer) is communicably coupled between the application servers 200 and the user systems 112 to distribute requests to the application servers 200. In one embodiment, the load balancer uses a least connections algorithm to route user requests to the application servers 200. Other examples of load balancing algorithms, such as round robin and observed response time, also can be used. For example, in certain embodiments, three consecutive requests from the same user could hit three different application servers 200, and three requests from different users could hit the same application server 200. In this manner, system 116 is multi-tenant, wherein system 116 handles storage of, and access to, different objects, data and applications across disparate users and organizations.

As an example of storage, one tenant might be a company that employs a sales force where each salesperson uses system 116 to manage their sales process. Thus, a user might maintain contact data, leads data, customer follow-up data, performance data, goals and progress data, etc., all applicable to that user's personal sales process (e.g., in tenant data storage 122). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 116 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 116 might also maintain system level data usable by multiple tenants or other data. Such system level data might include industry reports, news, postings, and the like that are sharable among tenants.

In certain embodiments, user systems 112 (which may be client systems) communicate with application servers 200 to request and update system-level and tenant-level data from system 116 that may require sending one or more queries to tenant data storage 122 and/or system data storage 124. System 116 (e.g., an application server 200 in system 116) automatically generates one or more SQL statements (e.g., one or more SQL queries) that are designed to access the desired information. System data storage 124 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table.”

In some multi-tenant database systems, tenants may be allowed to create and store custom objects, or they may be allowed to customize standard entities or objects, for example by creating custom fields for standard objects, including custom index fields. U.S. Pat. No. 7,779,039, filed Apr. 2, 2004, entitled “Custom Entities and Fields in a Multi-Tenant Database System”, which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

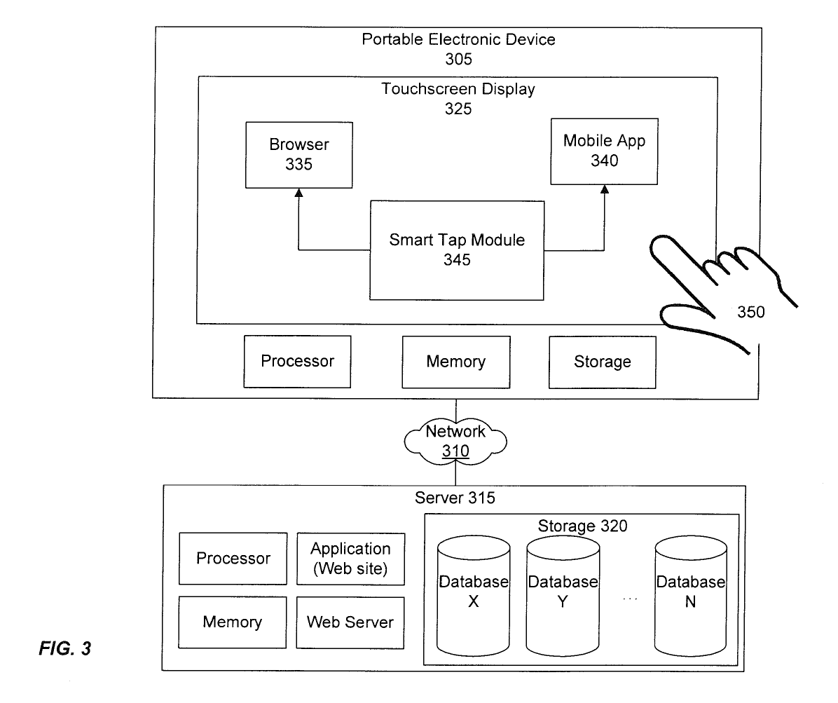

FIG. 3 shows a block diagram of a specific implementation of a system for an improved touchscreen interface. This system includes a client 305. There can be any number of clients. The client may access over a network 310 a server 315. The server includes components similar to the components in system 116 as shown in FIGS. 1-2 and described above. For example, the server includes a processor, memory, applications, and storage 320. The storage may include one or more databases such as a database X, a database Y, and so forth. The server is optional and is not included in other implementations.

The client is a general purpose computer with hardware and software, such as shown by user system 112 (FIGS. 1-2) and described above. For example, the client may include a processor, memory, and storage. The client executes executable code (or computer-readable code) that embodies a technique or algorithm as described in this application. In a specific implementation, the client is a portable electronic device (e.g., smartphone, tablet computer, or hand-held gaming device). Some specific examples of portable electronic devices include the iPad® and iPhone® from Apple Inc., the Galaxy Tab from Samsung, and the HTC Desire and Nexus One® from HTC Corporation. The portable electronic device may include an operating system such as iOS from Apple, Android from Google, and Windows Mobile and Windows Phone from Microsoft.

In this specific implementation, the portable electronic device includes an electronic touchscreen display or screen 325. Application programs are made available to a user through the display. A browser 335 is an example of an application program. The browser can request, receive, and process data from the user, server, or both. The data can be shown via the display. A mobile application program 340 is another example of an application program. The mobile application program may be referred to as a mobile app. A mobile app is a software application designed to run on smartphones, tablet computers, or other mobile devices. The mobile app may be pre-installed on the client device during manufacture, can be downloaded by the user from various mobile software distribution platforms (e.g., Apple App Store, Amazon Appstore, Google play, and others), or can be a web application delivered over the hypertext transfer application protocol (HTTP) and which can use server-side processing, client-side processing (e.g., JavaScript), or both to provide an application-like experience within a Web browser.

In a specific embodiment, there is a smart tap code module 345 that executes on the portable electronic device. The module may be provided to, embedded in, or integrated with the browser, a mobile app, or operating system of the portable electronic device. The module code may be obtained via the network and Web site. For example, the module code may be embedded in a Web page that is transmitted from the server to the portable electronic device. The module may function at an application program level or an operating system level. The module may be implemented as a script, add-in, plug-in, macro, library, extension, filter, or device driver.

The smart tap module provides for enhanced user selection of interactive elements on the display. An interactive element can include an icon, link (e.g., text hyperlink), or any other visual or graphical object that can be selected to cause an operation or event to occur. The operation can include accessing a resource such as a Web page, document, file, image, video, audio data, service (e.g., Web service), program, and so forth. The resource may be stored remote from the client such as at the server and accessed over the network. Alternatively, the resource may be stored at the client and accessed locally. More particularly, accessing the resource may include displaying, opening, or closing a record, page, document, window, panel, or box, launching an application, exiting an application, starting or stopping a service, or executing computer code—just to name a few examples.

In this specific embodiment, display 325 is touch-sensitive such that it can detect the presence and location of a touch within the display area. In a device having a touch-sensitive display, user input may be provided by a finger gesture such as by a tap of a user's finger 350 on a surface of the display. For example, the display may include first and second interactive elements. A user can select the first interactive element by tapping or touching a location on the display surface corresponding to the first interactive element. Likewise, the user can select the second interactive element by tapping or touching another location on the display surface corresponding to the second interactive element. User input may instead or additionally be provided using a stylus or other input device (e.g., mouse).

Generally, the display of a portable electronic device is made relatively small so that the device can easily transported and carried such as in a person's pocket, purse, briefcase, or bag. Multiple interactive elements may be shown on the display so that the user does not have to click through many different levels in order to access or see the desired data.

It can be difficult, however, for a user to select the desired interactive element from among the other interactive elements because each element may have a relatively small target area as compared to the user's finger (e.g., index finger or thumb). For example, the user may end up selecting one interactive element, but may have intended to select a different interactive element. This can be very frustrating. Having to magnify or zoom into the area having the interactive elements such as via a pinch-out gesture is inefficient because it requires additional step.

In a specific implementation, the smart tap module provides for one interactive element to have a larger tap target area than a tap target area of another interactive element. The large tap target area allows the one interactive element to be easily selected (e.g., tapped on). The module continues to allow the other interactive element to be selected if the user so desires. Thus, the user is presented with large areas in the interface that may be clicked, as well as smaller “sub-click” areas.

In a specific embodiment, the smart tap module allows a row shown on the display to have a first interactive element and a second interactive element, where an area of the second interactive element is greater than an area of the first interactive element. This allows the user to be presented with a row having a large area (e.g., second interactive element) so that it can be easily clicked as well as an additional smaller clickable area (e.g., first interactive element).

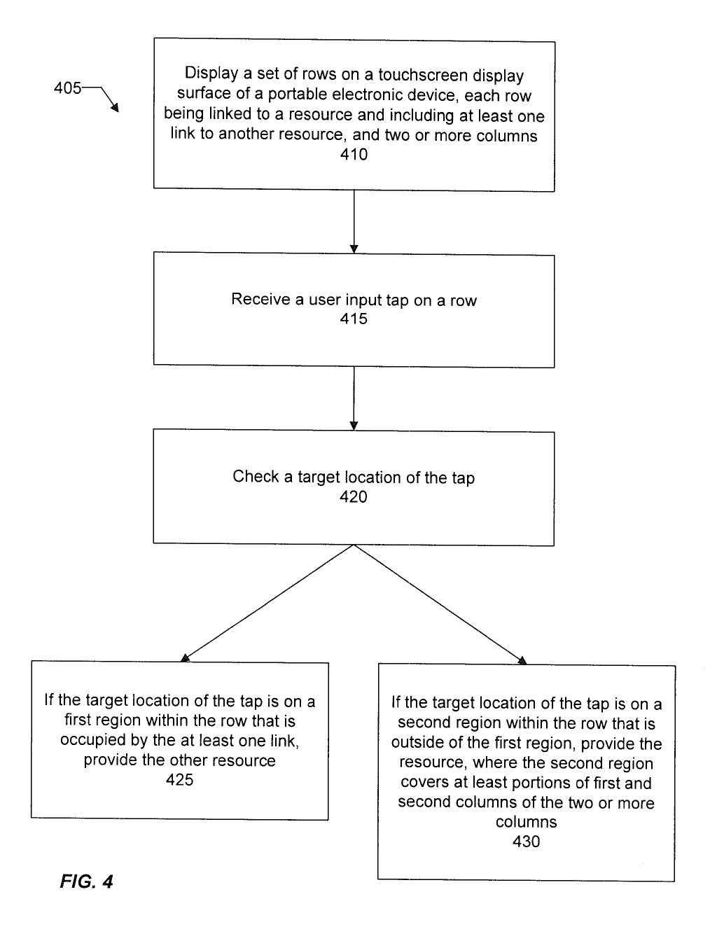

FIG. 4 shows an overall flow 405 of the smart tap module. Some specific flows are presented in this application, but it should be understood that the invention is not limited to the specific flows and steps presented. A flow of the invention may have additional steps (not necessarily described in this application), different steps which replace some of the steps presented, fewer steps or a subset of the steps presented, or steps in a different order than presented, or any combination of these. Further, the steps in other implementations of the invention may not be exactly the same as the steps presented and may be modified or altered as appropriate for a particular application or based on the data.

In a step 410, a set of rows is displayed on a touchscreen display surface of a portable electronic device. Each row is linked to or associated with a resource (e.g., first resource). In a specific implementation, the first resource includes a record and each row is linked to, represents, or identifies the record. The record may be stored at the server remote from the device. In this specific implementation, each row may include a subset of attributes or fields of the record. The record may be referred to as a primary record.

Each row further includes at least one link to another resource (e.g., second resource). In a specific implementation, the second resource includes another record. The at least one link is linked to or references the other record which may likewise be stored at the server remote from the device. The other record may be referred to as a secondary record.

In a specific implementation, the primary record and secondary record are associated to each other through a relationship such as a parent-child relationship or a primary key-foreign key relationship. The at least one link may display an attribute value stored in the secondary record.

In a specific implementation, the primary record and secondary record are stored in different databases. For example, the primary record may be stored in a database X (FIG. 3) and the secondary record may be stored in a database Y, different from database X. In another specific implementation, the records may be stored in the same database. Each row can include multiple links, i.e., two or more links. For example, a row can include three, four, five, six, seven, eight, nine, ten, or more than ten links. Each link can reference a different resource.

Each row further includes two or more columns or fields. For example, a first column of the two or more columns may store an attribute value of the primary record such as a name of the record. A second column of the two or more columns may store an attribute value of the secondary record such as a name of a user. The name may identify, for example, the user who created the primary record, owns the primary record, or last modified the primary record. One or both attribute values may be displayed as a link. For example, the name of the user may be displayed as a link such that clicking on the link opens the secondary record which may include a profile page of the user. The profile page may include contact information such as a phone number, e-mail address, mailing address, and so forth.

In a specific implementation, an “onclick” JavaScript event is attached to a row's list element. Tables A and B below show sample syntax of the “onclick” event in HTML and JavaScript, respectively.

TABLE A

<element onclick = “JavaScript code to be executed”>

TABLE B

object.onclick = “JavaScript code to be executed”

The parameter “JavaScript code to be executed” specifies the JavaScript code to be executed when the onclick event occurs. In a specific implementation, the JavaScript code to be executed is a “row press” event for the selected row. In this specific implementation, the row is associated with a uniform resource locator (URL) or identifier (URI). The URL may specify a resource (e.g., Web page or primary record) to be opened or loaded into a window on the touchscreen display. For example, the browser or app may transmit or send an HTTP request to the server to fetch the resource. It should be appreciated, however, that the code may instead or additionally cause a different event or operation to occur. For example, the URL “mailto:ed@example.com” may launch an e-mail composer with the address “ed@example.com” in the “To” field. The onclick event is merely one example of an event attribute. Other embodiments may instead include a different event attribute as desired such as ondlbclick, i.e., “on double click.”

In a step 415, a user input tap on a row is received. In a specific implementation, the user input tap is via the user placing or touching their fingertip or fingerpad on a surface of the display. It should be appreciated that a user may instead or additionally provide input using, for example, a stylus, mouse pointer, keyboard, or other input device.

In a step 420, the smart tap module checks a target location of the tap. In a step 425, if the target location of the tap is on a first region within the row that is occupied by the at least one link, the other resource associated with the at least one link is provided. For example, the other resource may include the secondary record and the secondary record may be shown on the display.

More particularly, in a specific implementation, the module checks whether the target location corresponds to an HTML anchor tag (e.g., “<a>”). A target location that corresponds to the anchor tag can indicate that the at least one link has been clicked. The anchor tag can be used with the hypertext reference attribute (e.g., “href”). This attribute defines an address to another resource such as a Web page, destination, or document (e.g., secondary record). In this specific implementation, if the target location corresponds to the anchor tag, the module does not fire a row press event that would cause the resource linked to the row to be provided (e.g., the primary record). The row press event may be suppressed, bypassed, or not executed. Thus, for example, rather than the primary record being displayed the secondary record may be displayed.

Alternatively, in a step 430, if the target location of the tap is on a second region within the row that is outside of the first region, the resource (e.g., primary record) is provided. For example, the row press event may be fired or executed so that the primary record can be shown on the display.

In a specific implementation, an area of the secondary region is greater than an area of the first region. In a specific implementation, the secondary region covers, fills, spans, or extends over at least a portion of the first column of the two or more columns of the row and at least a portion of the second column of the two or more columns. The second region provides the user with a tap target having a relatively large area that can be tapped in order to access the primary record. The secondary record, however, can still be accessed by tapping on the first region.

Thus, a displayed row can have two or more clickable regions or tap targets having different tap target areas. A technique as described in this application allows, in effect, a developer or administrator to associate, assign, attach, or link the second region having the larger tap target area to the resource (e.g., record) that is likely to be frequently accessed (e.g., the primary record). The resource that is likely to be less frequently accessed (e.g., the secondary record) can be associated with the first region having the smaller tap target area.

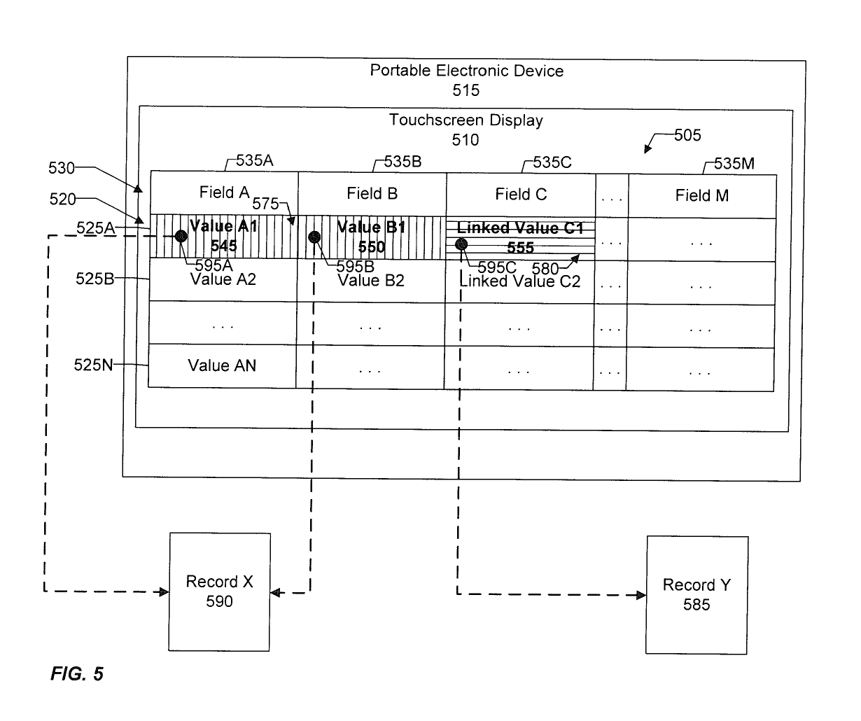

FIGS. 5-7 show some examples of a row having large and small clickable regions or tap targets. FIG. 5 shows a table 505 displayed on a touchscreen display 510 of a portable electronic device 515. The table includes a set of rows 520 (e.g., rows 525A . . . 525N) and a set of columns or fields 530 (e.g., columns 535A . . . 535M). For example, a first row 525A includes a first column 545, a second column 550, and a third column 555. Each cell of the table can be identified by its corresponding row and column. For example, a value A1 is shown in the first row, first column. A value B1 is shown in the first row, second column. A linked value C1 is shown in the first row, third column, and so forth.

In the example shown in FIG. 5, a row includes three columns. It should be appreciated, however, that there can be any number of rows and any number of columns. In a specific implementation, a row includes two or more columns. For example, a row can have two, three, four, five, six, seven, eight, nine, ten, or more than ten columns.

The first row includes a first region 575 and a second region 580. The first region is shown on FIG. 5 using a fill pattern. The second region is shown on FIG. 5 using a different fill pattern. The regions represent interactive elements (e.g., clickable areas) or tap targets that can be selected (e.g., clicked, or tapped on). For example, linked value C1 occupies the first region and is associated with, linked to, or references a first resource such as a record Y 585. In this specific embodiment, tapping on the first region causes record Y to be fetched and shown on the display. The second region is associated with, is linked to, or references a second resource, different from the first resource, such as a record X 590. Tapping on the second region causes record X to be fetched and shown on the display.

As shown in the example of FIG. 5, an area or tap target area of the second region is greater than an area or tap target area of the first region. In this example, the second region covers the first and second columns. Thus, a user can tap on any location within the second region to access record X. For example, the user can tap on a first location 595A in the first column to access record X. The user can tap on a second location 595B in the second column to access record X. Alternatively, the user can tap on a third location 595C in the third column to access record Y.

The second region may completely cover the first and second columns. The second region may cover the first column and at most a portion of the second column. The second region may cover at least a portion of each column of the two or more columns. As shown in the example of FIG. 5, the second region is within the row and is outside of the first region. For example, the second region is inside the row and does not overlap the first region. The first region is inside the row and does not overlap the second region.

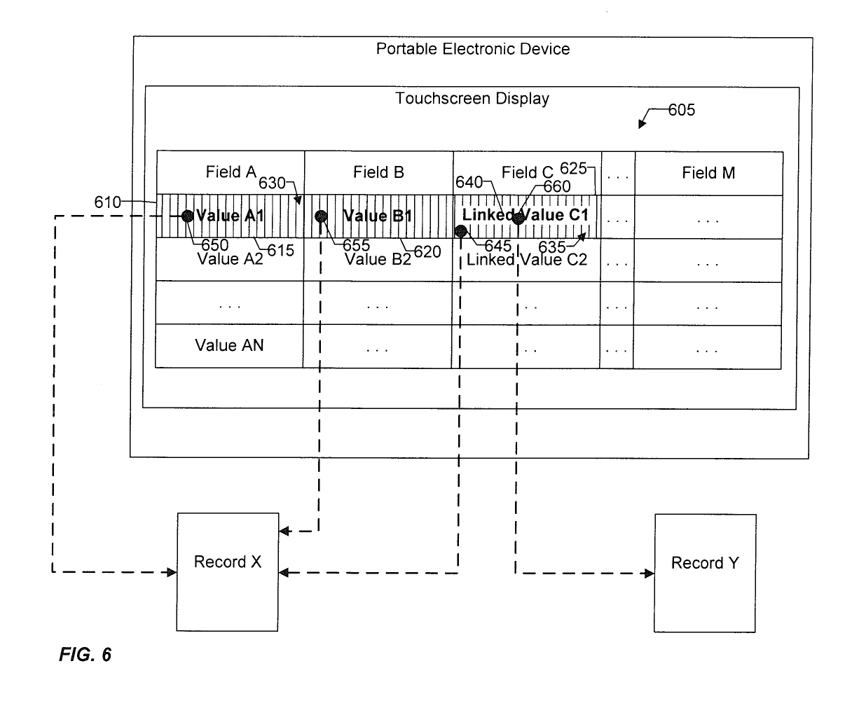

FIG. 6 shows another example of a row having large and small clickable regions or tap targets. A table 605 is similar to table 505 shown in FIG. 5. For example, a row 610 includes a first column 615, a second column 620, and a third column 625. A first region 630 is shown on FIG. 6 using a fill pattern.

As compared to FIG. 5, however, in FIG. 6 the second region covers a portion 635 of the third column holding a linked value C1. A second region 640 can be considered to be linked value C1 itself. The example shown in FIG. 6 allows the user to tap on a location 645 within the third column in order to access record X. Similar to FIG. 5, record X may also be accessed by tapping on locations 650, and 655 within the first and second columns, respectively. As in FIG. 5, record Y that is referenced by linked value C1 can also be accessed. In FIG. 6, however, record Y is accessed by tapping 660 on linked value C1 itself.

FIG. 6, as compared to FIG. 5, offers a larger tap target for record X. The trade-off, however, is a smaller tap target for record Y. In some cases, the implementation shown in FIG. 5 is more desirable than the implementation shown in FIG. 6. For example, if the displayed size of linked value C1 as shown in FIG. 5 is relatively small (e.g., has a relatively few number of characters) the implementation shown in FIG. 5 may be more desirable because FIG. 5 provides a greater tap target area in which record Y can be accessed as compared to the example shown in FIG. 6. That is, record Y can be accessed by tapping on linked value C1 itself or on an area within third column.

In other cases, the implementation show in FIG. 6 is more desirable than the implementation shown in FIG. 5. For example, as discussed above, the implementation shown in FIG. 6 offers a larger tap target area for record X as compared to the example shown in FIG. 5. If the displayed size of linked value C1 as shown in FIG. 6 is relatively large (e.g., has a relatively large number of characters), the trade-off of having a reduced tap target area to access record Y will not be detrimental. Other factors that may be considered include the likelihood or expected frequency that record X will be accessed versus record Y, a ratio of the area of the second region (e.g., the tap target area for record X) to the area of the first region (e.g., the tap target area of record Y), displayed link size, and so forth. In a specific implementation, the second region covers at least a portion of each column of the two or more columns and at most a portion of a single column of the two or more columns, where the at least one link is displayed in the single column

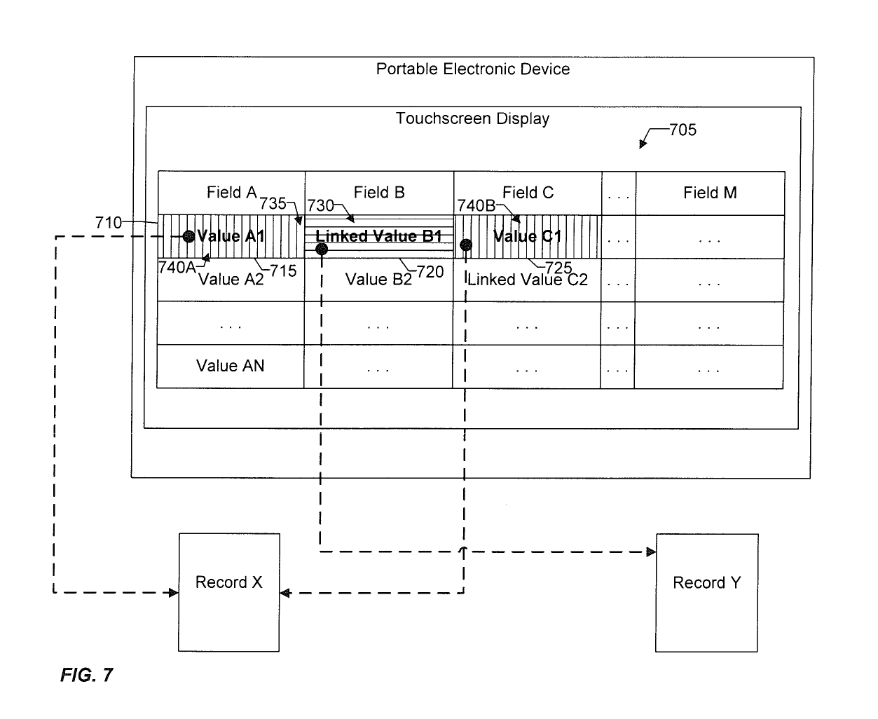

FIG. 7 shows another example of a row having large and small clickable regions or tap targets. A table 705 is similar to table 505 shown in FIG. 5. For example, a row 710 includes a first column 715, a second column 720, and a third column 725. A first region 730 is shown on FIG. 7 using a fill pattern. A second region 735 is shown using a different fill pattern.

As compared to FIG. 5, however, the second region is split into a first portion 740A and a second portion 740B. In other words, in FIG. 5, the second region or tap target area is continuous or unbroken. In FIG. 7, the second region or tap target area is discontinuous or broken. In FIG. 7, the first region is between the first and second portions of the second region.

Allowing the second region or tap target area to be broken into two or more portions offers flexibility in the placement, positioning, and layout of the particular columns. For example, in some cases it will be desirable to layout the column holding linked value B1 between the first and last columns. For example, typically people read from left-to-right. If the column holding linked value B1 includes very important information then it may be desirable to place the column closer to a left-hand side of the table than a right-hand side of the table so that the information in the column will be read and seen earlier.

In a specific implementation, a method comprises embedding in a row a link referencing a first resource; and associating an onclick event to the row, wherein the onclick event comprises first code that references a second resource, second code that checks a tap target of a tap received on the row, and third code that determines whether the tap target is on the link, wherein if the tap target is not on the link, the second resource is provided, and if the tap target is on the link, the first resource is provided.

In another specific implementation, a method comprises displaying a plurality of rows on a touchscreen display surface, each row comprising a first tap target that is associated with a first reference to a first resource, and a second tap target that is associated with a second reference to a second resource; receiving a user input tap on a row; if the user input tap is on the first tap target, resolving the first reference to provide the first resource; and if the user input tap is on the second tap target, resolving the second reference to provide the second resource, wherein an area of the first tap target is greater than an area of the second tap target.

In various specific implementations, a number of pixels in the area of the first tap target is greater than a number of pixels in the area of the second tap target. An area of the first tap target covers at least a portion of a first column of the row, and at least a portion of a second column of the row. A ratio of the area of the first tap target to the area of the second tap target is N:1, wherein N is a number greater than 1. N ranges from about 1.5 to about 10. The first reference comprises a first uniform resource locator (URL) that identifies the first resource, and the second reference comprises a second URL that identifies the second resource. The first reference comprises first text linked to the first resource, and the second reference comprises second text linked to the second resource, wherein a length of the first text is less than a length of the second text. A number of characters in the first text is less than a number of characters in the second text. Providing the first resource comprises displaying the first resource on the display surface. Providing the second resource comprises displaying the second resource on the display surface.

This patent application describes techniques to improve a user's experience when interacting with a touchscreen display of a portable electronic device. It should be appreciated, however, that the invention is not limited to portable electronic devices. Aspects of the invention may be implemented in any device, machine, product, or information appliance having a touchscreen display such as information kiosks (e.g., museum information kiosk), room automation systems, automobiles, large appliances (e.g., refrigerators), planes, boats, and so forth.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method comprising:
displaying a plurality of rows on a touchscreen display surface of a portable electronic device, each row being linked to a first resource, and each row comprising at least one link to a second resource, and two or more columns;
receiving a user input tap on a row of the plurality of rows displayed on the touchscreen display surface;
if the user input tap is on a first region within the row that is occupied by the at least one link, providing the first resource; and
if the user input tap is on a second region within the row that is outside of the first region, providing the second resource, wherein the second region covers at least a portion of a first column of the two or more columns of the row, and at least a portion of a second column of the two or more columns of the row.

2. The method of claim 1 wherein the first resource comprises a first record stored in a first database, and the second resource comprises a second record stored in a second database, different from the first database.

3. The method of claim 1 wherein the second region comprises a first portion and a second portion, and the first region is between the first portion and the second portion.

4. The method of claim 1 wherein the providing the first resource comprises:
transmitting from the portable electronic device to a server a request for a record identified by an attribute shown in the row;
receiving the record at the portable electronic device; and
displaying attributes of the record on the portable electronic device.

5. The method of claim 1 comprising:
attaching an onclick event to the row in order to fire, upon user selection of the row, a row press event to provide the second resource;
after the receiving a user input tap, checking a target of the user input tap;
if the target is on the at least one link, not firing the row press event; and
if the target is not on the at least one link, firing the row press event.

6. A machine-readable medium carrying one or more sequences of instructions, which instructions, when executed by one or more processors, cause the one or more processors to carry out the steps of:
displaying a plurality of rows on a touchscreen display surface of a portable electronic device, each row being linked to a first resource, and each row comprising at least one link to a second resource, and two or more columns;
receiving a user input tap on a row of the plurality of rows displayed on the touchscreen display surface;
if the user input tap is on a first region within the row that is occupied by the at least one link, providing the first resource; and
if the user input tap is on a second region within the row that is outside of the first region, providing the second resource, wherein the second region covers at least a portion of a first column of the two or more columns of the row, and at least a portion of a second column of the two or more columns of the row.

7. The machine-readable medium of claim 6 wherein the first resource comprises a first record stored in a first database, and the second resource comprises a second record stored in a second database, different from the first database.

8. The machine-readable medium of claim 6 wherein the second region comprises a first portion and a second portion, and the first region is between the first portion and the second portion.

9. The machine-readable medium of claim 6 wherein the providing the first resource comprises:
transmitting from the portable electronic device to a server a request for a record identified by an attribute shown in the row;
receiving the record at the portable electronic device; and
displaying attributes of the record on the portable electronic device.

10. The machine-readable medium of claim 6 comprising:
attaching an onclick event to the row in order to fire, upon user selection of the row, a row press event to provide the second resource;
after the receiving a user input tap, checking a target of the user input tap;
if the target is on the at least one link, not firing the row press event; and
if the target is not on the at least one link, firing the row press event.

11. An apparatus comprising:
a processor; and
one or more stored sequences of instructions which, when executed by the processor, cause the processor to carry out the steps of:
displaying a plurality of rows on a touchscreen display surface of a portable electronic device, each row being linked to a first resource, and each row comprising at least one link to a second resource, and two or more columns;
receiving a user input tap on a row of the plurality of rows displayed on the touchscreen display surface;
if the user input tap is on a first region within the row that is occupied by the at least one link, providing the first resource; and
if the user input tap is on a second region within the row that is outside of the first region, providing the second resource, wherein the second region covers at least a portion of a first column of the two or more columns of the row, and at least a portion of a second column of the two or more columns of the row.

12. The apparatus of claim 11 wherein the first resource comprises a first record stored in a first database, and the second resource comprises a second record stored in a second database, different from the first database.

13. The apparatus of claim 11 wherein the second region comprises a first portion and a second portion, and the first region is between the first portion and the second portion.

14. The apparatus of claim 11 wherein the providing the first resource comprises:
transmitting from the portable electronic device to a server a request for a record identified by an attribute shown in the row;
receiving the record at the portable electronic device; and
displaying attributes of the record on the portable electronic device.

15. The apparatus of claim 11 wherein the one or more stored sequences of instructions which, when executed by the processor, cause the processor to carry out the steps of:
attaching an onclick event to the row in order to fire, upon user selection of the row, a row press event to provide the second resource;
after the receiving a user input tap, checking a target of the user input tap;
if the target is on the at least one link, not firing the row press event; and
if the target is not on the at least one link, firing the row press event.

16. A method for transmitting code comprising:
transmitting code to display a plurality of rows on a touchscreen display surface of a portable electronic device, each row being linked to a first resource, and each row comprising at least one link to a second resource, and two or more columns;
transmitting code to receive a user input tap on a row of the plurality of rows displayed on the touchscreen display surface;
transmitting code to if the user input tap is on a first region within the row that is occupied by the at least one link, provide the first resource; and
transmitting code to if the user input tap is on a second region within the row that is outside of the first region, provide the second resource, wherein the second region covers at least a portion of a first column of the two or more columns of the row, and at least a portion of a second column of the two or more columns of the row.

17. The method of claim 16 wherein the first resource comprises a first record stored in a first database, and the second resource comprises a second record stored in a second database, different from the first database.

18. The method of claim 16 wherein the second region comprises a first portion and a second portion, and the first region is between the first portion and the second portion.

19. The method of claim 16 wherein the transmitting code to provide the first resource comprises:
transmitting code to transmit from the portable electronic device to a server a request for a record identified by an attribute shown in the row;
transmitting code to receive the record at the portable electronic device; and
transmitting code to display attributes of the record on the portable electronic device.

20. The method of claim 16 comprising:
transmitting code to attach an onclick event to the row in order to fire, upon user selection of the row, a row press event to provide the second resource;
transmitting code to after receipt of a user input tap, check a target of the user input tap;
transmitting code to if the target is on the at least one link, not fire the row press event; and
transmitting code to if the target is not on the at least one link, fire the row press event.
